(19) United States
(12) Patent Application Publication
(10) Pub. No.: US 2004/0190585 A1
(43) Pub. Date: Sep. 30, 2004

(54) Method to calibrate a temperature sensitive ring oscillator with minimal test time

(75) Inventors: Zachary Erich Berndlmaier, North Hero, VT (US); Daniel Lawrence Stasiak, Rochester, MN (US); Michael Fan Wang, Austin, TX (US)

Correspondence Address: Gregory W. Carr, 670 Founders Square, 900 Jackson Street, Dallas, TX, 75202, US

(73) Assignee: International Business Machines Corporation, Armonk, NY

(21) Appl. No.: 10/401,326

(22) Filed: Mar. 27, 2003

(51) Int. Cl. G01K 15/00

(52) U.S. Cl. 374/1

(57) ABSTRACT

The present invention provides for calibrating a TSRO with two tests, wherein generating a first or second calibration value does not substantially alter the temperature performed within the first or second test. The first calibration value is generated during a first test at a first temperature. The first test can be a wafer test, a module test, a burn-in test, and so on. The first calibration value is stored with an e-fuse in the integrated circuit. A second calibration value is generated during a second integrated circuit test of the integrated circuit at a second temperature. The second test can be a test that is performed at a temperature other than the first test. The second calibration value is stored with an e-fuse in the integrated circuit.

### CROSS-REFERNCED APPLICATION

The present application cross-references U.S. application Ser. No. ______ (Docket AUS920020710US1), entitled “METHOD TO CALIBRATE A CHIP WITH MULTIPLE TEMPERATURE SENSITIVE RING OSCILLATORS BY CALIBRATING ONLY ONE TSRO,” invented by Joachin Gerhard Clabes, et al., and filed on ______.

### TECHNICAL FIELD

The invention relates generally to calibrating a temperature sensitive ring oscillator (TSRO) and, more particularly, to calibrating a TSRO with minimal test time.

### BACKGROUND

Transistors can be used as logical switches in an integrated circuit (IC). Transistors generate heat when switching from an off state to an on state, or from an on state to an off state, within the IC. If this heat is neither properly dissipated nor otherwise accounted for or compensated, the transistor can experience degeneration leading to transistor failure.

However, although the IC can have an associated temperature sensor to detect excessive heat, there can be significant variation in the readings obtained from the temperature sensor from IC to IC. Therefore, a calibration of the temperature sensor is performed to compensate for this variation. Conventionally, one method of calibration is to generate a temperature in the IC environment and then calibrate the temperature sensor or temperature sensors at that temperature. In other words, determine what the readings of the temperature sensors are at a given temperature and use this as a basis for comparison when determining an unknown temperature. In a conventional system, the IC is cooled or heated to a given known temperature, and the readings from the temperature sensor are calibrated for that temperature. This is a time consuming process, however, and unacceptably cost or labor intensive for some individual ICs.

Therefore, what is needed is a way to calibrate an IC that solves at least some of the disadvantages associated with conventional calibration of ICs.

### SUMMARY OF THE INVENTION

The present invention provides for calibrating a TSRO with two tests, wherein generating a first or second calibration value does not substantially alter the temperature performed within the first or second test. The first calibration value is generated during a first test at a first temperature. The first calibration value is stored with an e-fuse in the integrated circuit. A second calibration value is generated during a second integrated circuit test of the integrated circuit at a second temperature. The second calibration value is stored with an e-fuse in the integrated circuit.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 schematically depicts an e-fuse burner and an integrated circuit comprising a TSRO and a plurality of e-fuses;

FIG. 2 schematically illustrates an external memory device and an integrated circuit comprising a TSRO and a plurality of erasable memory elements; and

FIG. 3 illustrates a method for employing temperature measurements in a plurality of testing environments for calibration of a TSRO.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

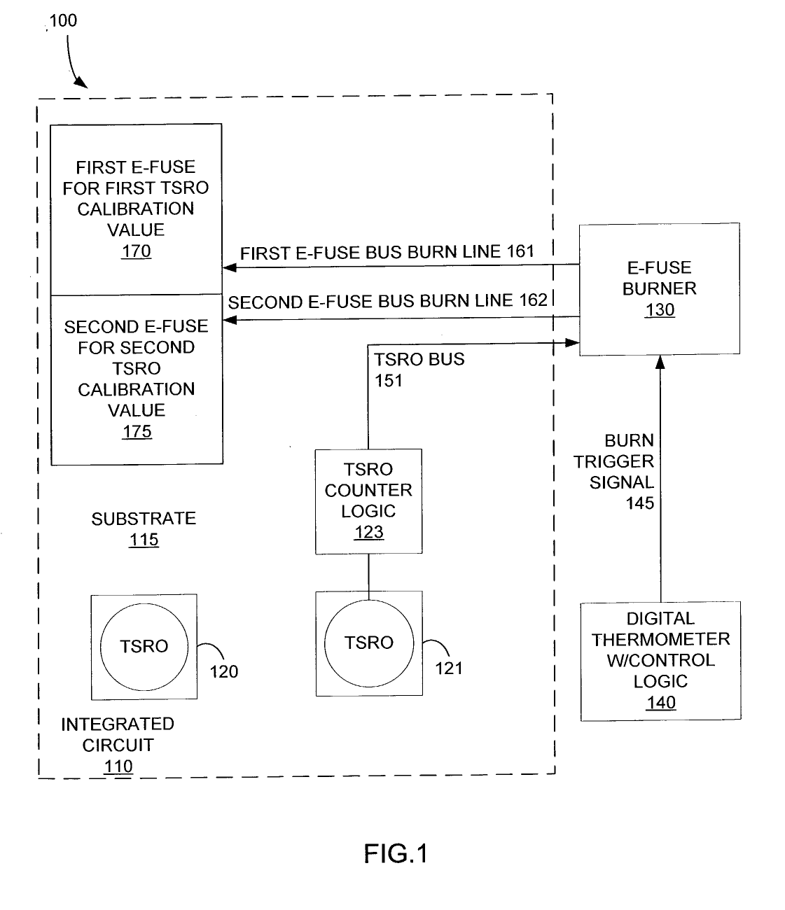

Turning to FIG. 1, disclosed is an IC calibration system 100. The system 100 has an integrated circuit (IC) 110. The IC 110 has a plurality of TSROs 120, 121 attached to a substrate 115. Generally, a ring oscillator consists of a number of gain stages in a feedback loop. With the correct configuration, phase shift, and so on, the output of a ring oscillator oscillates at a certain frequency, determined by the ring oscillator components. A TSRO further employs a temperature sensitive element to affect the characteristics of the oscillation, such as number of oscillation cycles per second.

In FIG. 1, coupled to the TSRO 121 is a TSRO counter 123. In an alternative embodiment, the TSRO 120 acon be coupled to the TSRO counter logic 123. Generally, the TSRO counter logic 123 measures the number of oscillations of a TSRO and forwards that information as appropriate. Furthermore, the TSRO counter logic 123 controls aspects of TSRO 120, 121 functionality. In FIG. 1, the TSRO counter 123 monitors and controls a TSRO logic 121, and indicia of the numbers of oscillations measured by the TSRO logic counter 123 is forwarded to a e-fuse burner 123.

The system 100 further comprises a digital thermometer with control logic (“thermometer”) 140. Generally, the thermometer 140 measures the environmental temperature. When the environmental temperature reaches a programmed threshold, a burn trigger signal is transmitted over a burn trigger signal line 145 to an e-fuse burner 130. Once the burn trigger signal is generated, the thermometer 140 is reset. The thermometer 140 then waits for the environmental temperature to reach a second threshold, and then sends a second burn trigger signal.

The e-fuse burner 130, upon receiving a first burn trigger signal, reads oscillation indicia form the TSRO counter logic 123 over a TSRO bus 151. The oscillation indicia represents the number of cycles the TSRO 121 was oscillating at the temperature that triggered the first burn trigger signal. The first time the e-fuse burner 130 receives a burn trigger signal, it sends this TSRO oscillation indicia over a first e-fuse bus burn line 161 to a first e-fuse 170. The e-fuse burner 130, upon receiving a second burn trigger signal, reads further oscillation indicia from the TSRO counter logic 123 over the TSRO bus 151. The TSRO oscillation indicia represents the number of cycles the TSRO 121 was oscillating at the temperature that triggered the second burn trigger signal. The second time the e-fuse burner 130 receives a burn trigger signal, it sends this value over a second e-fuse bus burn line 162 to a second e-fuse 175.

In FIG. 1, the TSRO 121 calibrations are performed at two different times and temperatures. Generally, these two different times and temperatures are chosen to be at different temperatures that are inherent within tests that are performed upon the IC 110 independently of the need to generate temperatures for calibrating the various TSROs 120, 121 in the IC 110. A test can be generally defined as a process in which an IC 110 or part of an IC 110 is checked, wherein the checking includes at least some part or system of the IC 110 other than that involving the TSRO 120, 121.

A first time a TSRO 121 calibration can be performed is during the wafer test. Generally, the wafer test is performed when each processor has been fabricated within a chip and is then are tested to see whether the chip meets specification. Typically, all of the chips are still connected in the wafer.

The wafer testing typically occurs at a moderate/room temperature. This temperature can be 35 degrees Celsius. The calibration value (that is, the oscillation value) of the TSRO 121 is burned into the IC circuit 110 using the e-fuse 170 when the e-fuse burner 130 receives a first burn trigger signal over the burn trigger signal bus 145. This occurs when the temperature measured at the thermometer 140 is at a threshold temperature. E-fuses 170, 175 permanently store TSRO oscillations that have been translated into a binary code for retrieval when interpolating or extrapolating for a given temperature on the IC 110. E-fuses are generally memory elements that can be written to only once, but read many times. In a further embodiment, the “trigger” temperature measured by the thermometer 140 is also burned into the e-fuse 170, 175, as well as a binary code representing the number of oscillations of the TSRO 121.

A second TSRO 121 calibration can be performed during the “packaging” test mode. In the packaging test, the individual chips are placed in their chip containers (IC packaging), the chip containers having connector pins, and so on. Then, the chips are tested at a temperature that is generally higher than the wafer test. The packaging test is generally employed to determine whether the packaging of the chips into their individual module was performed correctly. The second e-fuse 175 in the IC 110 is stored with the number of cycles per second in binary notation for the associated TSRO 121 for the second trigger temperature.

Using the environmental temperature, inherent in the various testing procedures, for calibrating the TSRO 121, as opposed to generating an environmental temperature specifically for the purpose of calibrating the TSRO 121, can be useful in that the temperatures used for calibration of the TSRO 121 are already established as part of IC 110 testing. The system 100 takes advantage of the inherent temperature differentials in various testing procedures, in order to calibrate TSROs 121, thereby reducing time of testing and testing complexity.

In a further embodiment, TSRO 121 oscillation calibration information is generated during the “burn-in” test. Generally, the burn-in test is performed at a temperature that is higher than the module test, and the temperature is left there for a certain period of time. That time can be about fifteen minutes or so. In the burn-in test, the voltage and temperature of the chips are elevated to further quantify reliability of the parts, such as reliability problems that might not have been noticed in the wafer test or the module test. However, those of skill in the art understand that the burn-in test can be performed at a plurality of steps within the IC 110 fabrication process. In a still further embodiment, any two tests that are performed upon the IC 110 having an inherent temperature differential can be used to calibrate the TSRO 121, instead of adding or subtracting heat from the system 100 in order to get a threshold TSRO calibration temperature.

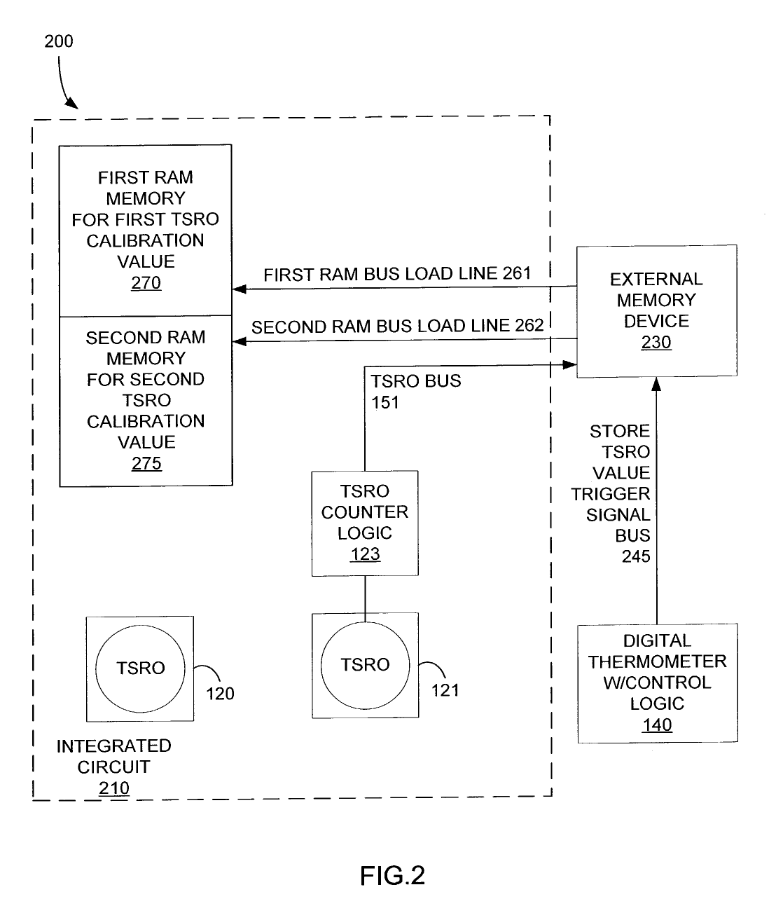

Turning now to FIG. 2, disclosed is a system 200. The system 200 has an IC 210. The IC 210 has the TSRO 121 coupled to the TSRO counter logic 123, which outputs oscillation indicia over the TSRO cycle bus 151. The system 200 further has a thermometer 140 which generates a first store TSRO calibration value trigger signal over a store TSRO calibration value trigger signal bus 245.

However, the system 200 employs an external memory device 230, such as a smart card. The external memory device 230 receives the burn trigger signal from the thermometer 140, and then reads and stores the TSRO counter logic 123 indicia. The external memory device 230 stores the first TSRO indicia over the first Random Access Memory (RAM) bus load line 261 to a first RAM 270. The external memory device 230 stores the second TSRO indicia over the second Random Access Memory (RAM) bus load line 262 to a second RAM 275. The RAM 270, 275 can be erased by new values from the external memory device 230.

In employing an external memory device 230, such as a smart card, in such a manner can allow new TSRO calibration values to be stored. New TSRO calibration values can be employed if there was an error in the original calibration process, or some characteristic or parameter of the IC 110, 210 or its environment, changes.

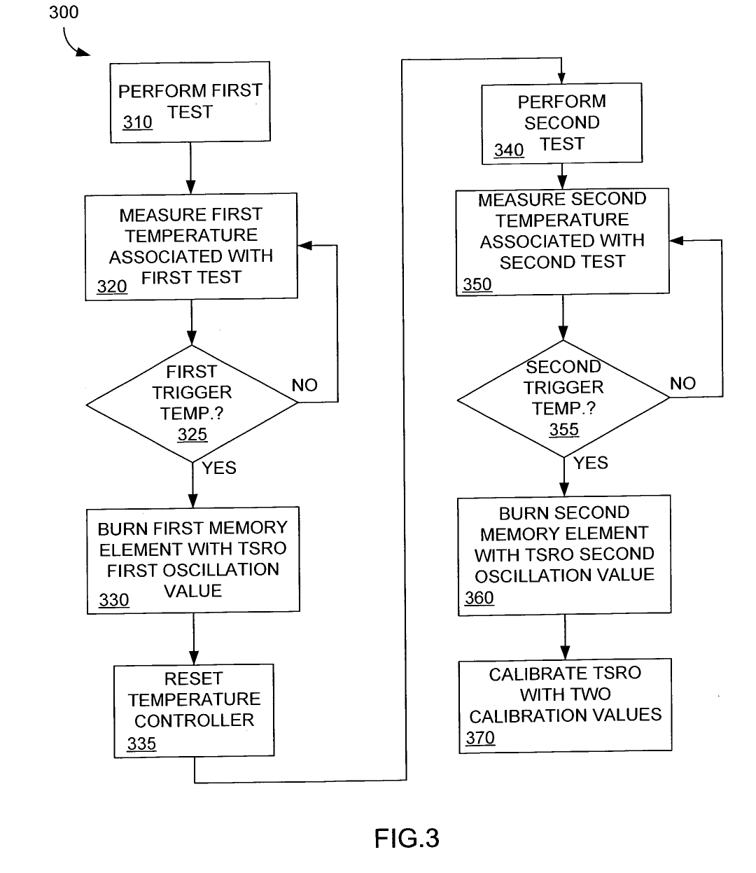

Turning now to FIG. 3, disclosed is a method 300 for calibrating the TSRO 121 in two separate testing environments. These testing environments have different temperatures associated with them.

In step 310, a first test of the IC 110 is performed. This first test can be a wafer test, a module test, a burn-in test, or some other test associated with testing the IC itself, and not just the TSRO 121. Each of these tests has an associated corresponding temperature.

In step 320, the first temperature of the first test is measured by the thermometer 140. In step 325, the thermometer 140 determines whether a threshold temperature has been reached. If it has been reached, the thermometer 140 transmits a burn trigger signal to the e-fuse burner 130 and proceeds to step 330. If, at step 325, the threshold temperature has not been reached, step 320 is re-executed and the thermometer 140 again reads the temperature at step 320. This loop continues until the threshold temperature is reached.

When the threshold temperature has been reached, in step 330, the e-fuse burner 130 burns the value received from the TSRO counter logic 123 over the burn line 160 into the first e-fuse 170. In step 335, the burn trigger signal is reset.

In step 340, a second test of the IC 110 is performed. This test can be a wafer test, a module test, a burn-in test, or some other test associated with testing the IC itself, and not just the TSRO 121. Furthermore, the second test is not performed at the same temperature as the first test. Each of these tests has an associated corresponding temperature.

In step 350, the temperature of the second test is measured by the thermometer 140. In step 255, the thermometer 140 determines whether a second threshold temperature has been reached. If it has been reached, the thermometer 140 transmits a burn trigger signal to the e-fuse burner 130 and proceeds to step 360. If, at step 355, the threshold temperature has not been reached, step 350 is re-executed and the thermometer 140 again reads the temperature. This loop continues until the threshold temperature is reached.

When the threshold temperature has been reached, in step 360, the e-fuse burner 130 burns the value received from the TSRO counter logic 123 over the second burn line 162 into the second e-fuse 175. In step 370, the TSRO 121 is calibrated through employment of the first and second calibration values. In other words, it is interpolated or extrapolated to what temperature a TSRO 120, 121 measurement corresponds.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A method for calibrating a temperature sensitive ring oscillator (TSRO) on a substrate with reduced test time, comprising:
generating a first calibration value during a first test associated with an integrated circuit at a first temperature;
storing the first value with e-fuses in the integrated circuit;
generating a second calibration value during a second test of the integrated circuit at a second temperature;
storing the second calibration value with e-fuses in the integrated circuit; and
calibrating the TSRO with the first and second calibration values.

2. The method of claim 1, wherein generating a first calibration value associated with an integrated circuit further comprises generating a first calibration value associated with a substrate.

3. A method of calibrating a TSRO with two tests, wherein generating a first or second calibration value does not substantially alter the temperature performed within the first or second test, comprising:
generating the first calibration value during a first test associated with an integrated circuit at a first temperature;
storing the first calibration value with an e-fuse in the integrated circuit;
generating the second calibration value during a second test of the integrated circuit at a second temperature; and
storing the second calibration value with an e-fuse in the integrated circuit.

4. The method of claim 3, further comprising burning the first and second values into the first and second e-fuses with an e-fuse burner.

5. The method of claim 3, further comprising calibrating the TSRO with the first and second calibration values.

6. The method of claim 4, further comprising generating a burn trigger signal at a threshold temperature, wherein the burn trigger signal triggers the e-fuse burner.

7. The method of claim 3, wherein the tests can be a wafer test, a burn-in test, or a module test.

8. The method of claim 1, further comprising a step of storing indicia of the first temperature in the integrated circuit.

9. The method of claim 1, further comprising a step of storing indicia of the second temperature in the integrated circuit.

10. A method for calibrating a TSRO reduced test time, comprising:
generating a first calibration value during a first test associated with an integrated circuit at a first temperature;
storing the first value in an external memory device;
generating a second calibration value during a second test of the integrated circuit at a second temperature;
storing the second calibration value with the external memory device;
retrieving the first and second calibration values from the external memory device; and
storing the first and second calibration values from the external memory device into a first and second erasable memory device in the integrated circuit.

11. The method of claim 10, further comprising burning the first and second values into the first and second e-fuses with an e-fuse burner.

12. The method of claim 10, further comprising calibrating the TSRO with the first and second calibration values.

13. The method of claim 11, further comprising generating a burn trigger signal at a threshold temperature, wherein the burn trigger signal triggers the e-fuse burner.

14. The method of claim 10, wherein the tests can be a wafer test, a burn-in test, or a module test.

15. A system for calibrating a TSRO, comprising:
a TSRO;
an e-fuse burner coupled to the TSRO;
a thermometer coupled to the e-fuse burner;
a first and second e-fuse coupled to the e-fuse burner.

16. An integrated circuit, comprising:
a TSRO;
a first and second e-fuse coupled to the integrated circuit; and
a first and second e-fuse bus burn line coupled to the first and second e-fuses, respectively.

17. A system for calibrating a TSRO, comprising:
a TSRO;
an external memory device coupleable to the TSRO, wherein the external memory device is configured to accept indicia of output from the TSRO;
a thermometer coupled to the external memory device; and
a first and second erasable memory coupleable to the external memory device, wherein the first and second erasable memory devices are configured to accept indicia of output associated with the TSRO from the external memory device.

18. The system of claim 17, wherein the external memory device comprises a smart card.

19. The system of claim 17, wherein the thermometer is configured to generate a store TSRO value trigger signal when the temperature reaches a threshold.

20. The system of claim 18, wherein the threshold is associated with a wafer test, a module test, or a burn-in test.

21. A computer program product for calibrating a TSRO with two tests, wherein generating a first or second calibration value does not substantially alter the temperature performed within the first or second test, the computer program product having a medium with a computer program embodied thereon, the computer program comprising:
computer code for generating the first calibration value during a first test associated with an integrated circuit at a first temperature;
computer code for storing the first value with an e-fuse in the integrated circuit;
computer code for generating the second calibration value during a second test of the integrated circuit at a second temperature; and
computer code for storing the second value with an e-fuse in the integrated circuit.

22. A processor for calibrating a TSRO with two tests, wherein generating a first or second calibration value does not substantially alter the temperature performed within the first or second test, the processor including a computer program comprising:
computer code for generating the first calibration value during a first test associated with an integrated circuit at a first temperature;
computer code for storing the first value with an e-fuse in the integrated circuit;
computer code for generating the second calibration value during a second test of the integrated circuit at a second temperature; and
computer code for storing the second value with an e-fuse in the integrated circuit.
